(19) United States
(12) Patent Application Publication
(10) Pub. No.: US 2013/0334194 A1
(43) Pub. Date: Dec. 19, 2013

(54) TEMPERATURE CONTROL DEVICE SEAMED ON CLOTHES

(71) Applicant: CHIEN-CHOU CHEN, TAINAN (TW)

(72) Inventor: CHIEN-CHOU CHEN, TAINAN (TW)

(21) Appl. No.: 13/524,095

(22) Filed: Jun. 15, 2012

(51) Int. Cl. A41D 13/005; H05B 1/02

(52) U.S. Cl. 219/211; 219/490

(57) ABSTRACT

A temperature control device includes a button which is located in a hole of a cloth and sewed along the periphery of the button. The control unit is located in the recess of the button and a fixing member is connected to the rear side of the button to secure the control unit in the recess. The wires of the control unit extend through the fixing member and are hidden in the cloth. The temperature control device is secured with the cloth and does not hang randomly outside the cloth so that it is protected from being scratched, pulled or compressed.

### BACKGROUND OF THE INVENTION

1. Field of the Invention

The present invention relates to a temperature control device, and more particularly, to a temperature control device seamed on clothes and the wires are hidden in the clothes.

2. Description of Prior Art

There are many clothes designed used in cold areas and these clothes are equipped with heating pads and a temperature control device is connected to the heating pads so as to control the current passing through the heating pads and to control the temperature of the heating pads. Because the temperature control device is connected with the wires so that the temperature control device hangs on the clothes randomly. However, the randomly hanging temperature control device may be pulled or pressed unintentionally and broken.

Taiwan Published No. M392478 discloses a temperature control device which is in the form of a button and the temperature control device is directly sewed to the clothes and the wires are arranged properly. The temperature control device and the wires are sewed in a special way such that they are secured during washing processes and are not pulled out from the clothes.

The present invention intends to provide a temperature control device which is sewed to the cloth and increases the aesthetic feature of the clothes, the temperature control device and the wires are positioned so that they are not scratched, pulled and broken.

### SUMMARY OF THE INVENTION

The present invention relates to a temperature control device and comprises a button having an operation portion extending centrally from the front side thereof and the operation portion protrudes from a hole of a cloth. A recess is defined in the rear side of the button and located corresponding to the operation portion. The button is sewed to the cloth along the periphery thereof by sewing threads. A control unit is located in the recess and has a circuit board. A trigger is located at the center of the circuit board and a temperature display member is connected to the circuit board and located beside the trigger. A micro processer is connected to the circuit board and electrically connected with the trigger and the temperature display member. At least three wires are connected to the circuit board. A fixing member is connected to the rear side of the button and secures the circuit board, the trigger and the temperature display member in the recess. The at least three wires extend beyond the fixing member and are hidden in the cloth.

The primary object of the present invention is to provide a temperature control device which is secured with the cloth and does not hang randomly outside of the cloth so that it is protected from being scratched, pulled or compressed.

The temperature control unit is sewed to the cloth along the periphery thereof and the contact area between the temperature control unit and the cloth is so limited so that when washing the cloth, the washing force is mostly applied to the cloth rather than to the temperature control unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the temperature control unit of the present invention;

FIG. 2 shows that the temperature control unit of the present invention is to be sewed to the cloth, and

FIG. 3 is a cross sectional view to show that the temperature control unit of the present invention is sewed to the cloth.

### DETAILED DESCRIPTION OF THE PREFERRED EMBODIMENT

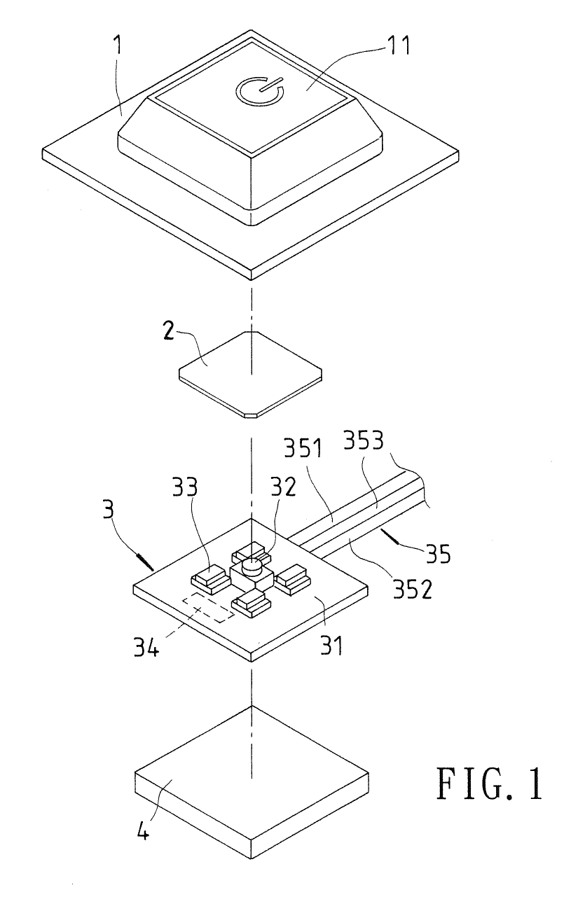

Referring to FIGS. 1 to 3, the temperature control unit of the present invention comprises a button 1, an observation plate 2, a control unit 3 and a fixing member 4. The button 1 has an operation portion 11 extending centrally from the front side thereof and the operation portion 11 protrudes from a hole 51 of a cloth 5. A recess 12 is defined in the rear side of the button 1 and located corresponding to the operation portion 11. The recess 12 has a stepped portion 121 defined in the inner periphery thereof. The button 1 is sewed to the cloth 5 along the periphery thereof by sewing threads 52.

The observation plate 2 is a transparent plate and engaged with the recess 12 and located in front of the control unit 3.

The control unit 3 is located in the recess 12 and has a circuit board 31, a trigger 32 located at the center of the circuit board 31, a temperature display member 33 connected to the circuit board 31 and located beside the trigger 32, a micro processer 34 connected to the circuit board 31 and electrically connected with the trigger 32 and the temperature display member 33, and at least three wires 35 connected to the circuit board 31. The circuit board 31 is in contact with the stepped portion 121. The temperature display member 33 can display the temperature by using a liquid screen, digital bars, multiple strips, multiple index light emitters or light emitters that vary colors according the temperatures. The at least three wires 35 includes a negative current input wire 351, a negative current output wire 352 and a positive current input/output wire 353, wherein the negative current output wire 352 and the positive current input/output wire 353 are respectively connected with the power supply and the heating unit.

The fixing member 4 and the button 1 are made by the same material which can be silicone. The fixing member 4 is integrally formed with the button 1 by pouring melted material of the fixing member 4 into the recess 12. The material seals the recess 12 when the material is cooled. The fixing member 4 secures the observation plate 2, the control unit 3, the circuit board 31, the trigger 32 and the temperature display member 33 in the recess 12. The at least three wires 35 extend through the fixing member 4 and hidden by the cloth 5. The at least three wires 35 are enclosed by the fixing member 4.

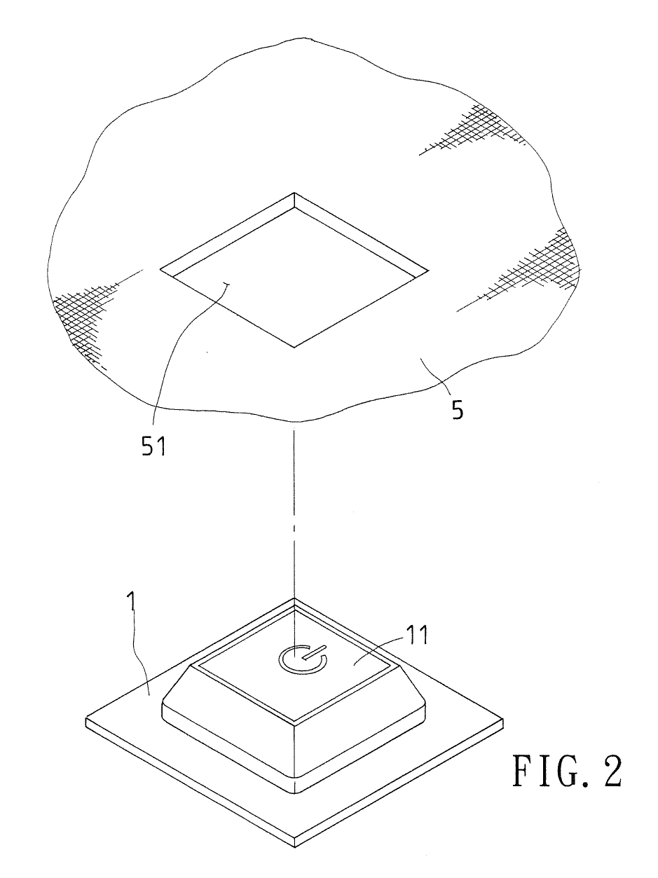

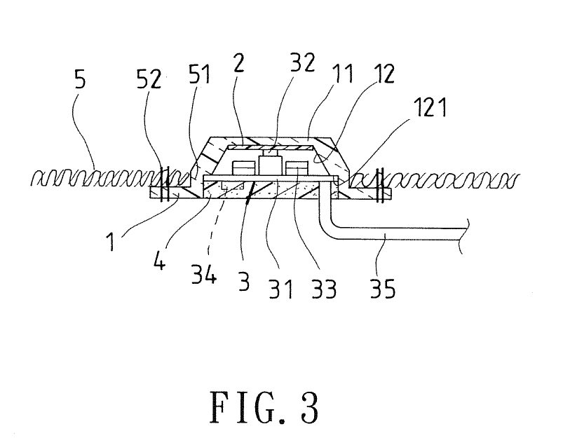

As shown in FIGS. 2 and 3, the button 1 is connected to the cloth along the periphery thereof and the rest portion of the button 1 is not secured to the cloth 5, so that when the cloth 5 is pulled, less force is applied to the button 1 which is secured to the cloth 5. When washing the cloth 5, most of the washing forces are applied to the cloth 5 and the button 1 is not likely separated from the cloth.

When the user adjusting the temperature control device, the user presses the operation portion 11 exposed beyond the cloth 5, the pressing force presses the observation plate 2 which bears the force evenly so that the trigger 32 is avoided form being damaged by the concentrate force. The trigger 32 does not penetrate through the operation portion 11 of the button 1. When the trigger 32 is compressed, the micro processer 34 is activated and current passes through the heating unit via the at least three wires 35. The temperature display member 33 that is electrically connected to the micro processer 34 displays the temperature. The light of the display passes through the observation plate 2 evenly so that the user can be acknowledged the current temperature.

Furthermore, the button 1 is sewed to the cloth 5 and the at least three wires 35 extending beyond the fixing member 4 and are hidden in the clothe 5, so that the button 1 and the at least three wires 35 do not hang outside of the cloth 5. This increases the aesthetic feature of the cloth 5 and the button 1 and the at least three wires 35 are protected.

While we have shown and described the embodiment in accordance with the present invention, it should be clear to those skilled in the art that further embodiments may be made without departing from the scope of the present invention.

What is claimed is:

1. A temperature control device comprising:
a button having an operation portion extending centrally from a front side thereof and the operation portion being adapted to protrude from a hole of a cloth, a recess defined in a rear side of the button and located corresponding to the operation portion, the button adapted to be sewed to the cloth along a periphery thereof by sewing threads;
a control unit located in the recess and having a circuit board, a trigger located at a center of the circuit board, a temperature display member connected to the circuit board and located beside the trigger, a micro processer connected to the circuit board and electrically connected with the trigger and the temperature display member, at least three wires connected to the circuit board, and
a fixing member connected to the rear side of the button and securing the circuit board, the trigger and the temperature display member in the recess, the at least three wires extending beyond the fixing member and adapted to be hidden in the clothe.

2. The device as claimed in claim 1, wherein the button has an observation plate which is a transparent plate, the observation plate is engaged with the recess and located in front of the control unit, the observation plate is fixed to the recess by the fixing member.

3. The device as claimed in claim 1, wherein the recess has a stepped portion defined in an inner periphery thereof and the circuit board is in contact with the stepped portion.

4. The device as claimed in claim 1, wherein the fixing member is integrally formed with the button by pouring melted material of the fixing member into the recess, the at least three wires are enclosed by the fixing member.

5. The device as claimed in claim 4, wherein the button and the fixing member are made by the same material.
